(19) United States
(12) Patent Application Publication
(10) Pub. No.: US 2009/0305674 A1
(43) Pub. Date: Dec. 10, 2009

(54) Device management in visited network

(75) Inventors: Veli-Matti Teittinen, Veikkola (FI); Mika Forssell, Soderkulla (FI); Jari Mustajarvi, Espoo (FI); Lucia Tudose, Espoo (FI); Janne Tervonen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/457,256

(22) Filed: Jun. 4, 2009

Related U.S. Application Data
(60) Provisional application No. 61/129,083, filed on Jun. 4, 2008.

(51) Int. Cl. H04M 1/66; H04W 4/00

(52) U.S. Cl. 455/411; 455/432.1

(57) ABSTRACT

An apparatus and method perform device management (DM) operations for a wireless network. One example includes receiving, at a network device, connection information of a roaming device in the wireless network. Next, at least one of a user profile and a corresponding roaming device profile are created in response to receiving the connection information, and a device management session may be established. In addition, a bootstrap message may be created based on at least one of the user profile and the corresponding roaming device profile and may be forwarded in order to initiate the device management session.

### CROSS-REFERENCE TO RELATED APPLICATIONS

This application claims the benefit of U.S. Provisional Application No. 61/129,083, filed Jun. 4, 2008, the contents of which are hereby incorporated by reference.

### BACKGROUND OF THE INVENTION

1. Field of the Invention

Embodiments of the present application relate to a device management (DM) solution for a wireless network to apply DM operations to visiting users and devices that do not have preconfigured static DM profiles.

2. Description of the Related Art

Due to different regulations, market environments and usage scenarios, connectivity providers typically employ various different network technologies, such as global system for mobile communications (GSM)/general packet radio system (GPRS), wideband code division multiple access (WCDMA), high speed packet data (HSPA), worldwide interoperability for microwave access (WiMAX), and wireless local area network (WLAN). These and other various different network technologies are needed to support the trends and services that are enabled by the new, powerful, multi-communication devices. In addition, virtual operators and service providers are competing with the incumbent network operators. Therefore, services are increasingly being accessed using different network technologies and multiple stakeholders. However, such heterogeneous network environments introduce complexity that today is visible even to an end user who is required to adjust devices manually, such as to configure connectivity and service settings manually.

Network discovery and selection (NWDS) is a technology being developed to automate discovering trusted and preferred networks and to make use of these networks. NWDS also allows a network operator to handle interoperability of mobility between 3rd generation partnership project (3GPP) and non-3GPP networks (e.g., between WCDMA and WLAN). Examples of conventional NWDS technologies include the IEEE Standard 802.21 and the 3GPP access network discovery and selection function (ANDSF).

Due to the various different network technologies, network operators are constantly presented with changes in the process of handling the mobility of their subscribers. Although, NWDS mechanisms are being standardized, the proposed 802.21 and ANDSF may not be finalized for some years. A DM-based network discovery and selection procedure can also be used by network operators to manage existing networks.

### SUMMARY OF THE INVENTION

According to embodiments of the present invention, a method can include receiving, at a network device, connection information of a roaming device. The method can also include creating at least one of a user profile and a corresponding roaming device profile in response to receiving the connection information, and initiating a device management session.

According to additional embodiments of the present invention an apparatus can include a receiver configured to receive connection information of a roaming device. The apparatus can also include a processor configured to create at least one of a user profile and a corresponding roaming device profile in response to receiving the connection information, and, to initiate a device management session.

According to further embodiments of the present invention a method can include transmitting, via a user equipment, connection information of a roaming user equipment to a network device. In response to transmitting the connection information, the method can also include initiating a device management session between the user equipment and the network device.

According to further embodiments of the present invention the apparatus can further include a transmitter configured to transmit connection information of a roaming user equipment to a network device. The apparatus can also include a processor configured to initiate a device management session between the user equipment and the network device in response to transmitting the connection information.

According to yet further embodiments of the present invention a method can include ending a session between a roaming device and a visited network. The method can also include storing and tagging connectivity settings of the ended session with the visited network in response to the roaming device moving out of the visited network, and re-connecting a connection between the roaming device and the visited network in response to the roaming device re-entering the communication range of the visited network by using the connectivity settings of the ended session used prior to re-connecting the connection.

According to further embodiments of the present invention an apparatus can include a memory configured to store and tag connectivity settings of an ended session between the apparatus and a visited network in response to the apparatus moving out of the visited network. The apparatus can also include a transmitter configured to re-connect a connection between the apparatus and the visited network in response to the apparatus re-entering the communication range of the visited network by using the connectivity settings of the ended session used prior to re-connection of the connection.

According to yet further embodiments of the present invention a method can include observing a roaming device in a network. The method can also include exchanging network connectivity and service information between the network and a home network of the roaming device. The method may further include creating at least one of a temporary device profile and a temporary user profile, the at least one profile including credentials to enable the network to apply device management operations to the roaming device. The method may also include generating authentication credentials for the at least one profile, adding the credentials to the at least one profile, and initiating a device management session.

According to yet further embodiments of the present invention an apparatus can include a receiver configured to receive a signal confirming that a roaming device is operating in a network, and a transmitter configured to exchange network connectivity and service information between the network and a home network of the roaming device. The apparatus may also include a processor configured to create at least one of a temporary device profile and a temporary user profile, the at least one profile includes credentials to enable the network to apply device management operations to the roaming device, and to generate authentication credentials for the at least one profile. The processor can also be configured to add the credentials to the at least one profile, and initiate a device management session.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 is a flow chart of a roaming device management method in accordance with embodiments of the present invention;

FIG. 2 is a process diagram illustrating messages exchanged in a roaming device management process flow in accordance with embodiments of the present invention; and

FIG. 3 is a schematic diagram of a roaming device management system in accordance with embodiments of the present invention.

### DETAILED DESCRIPTION OF THE PREFERRED EMBODIMENTS

It will be readily understood that the components of the present invention, as generally described and illustrated in the figures herein, can be implemented in a wide variety of different configurations. Thus, the following detailed description of the embodiments of a method, apparatus, and system, as represented in the attached figures, is not intended to limit the scope of the invention, but is merely representative of selected embodiments of the invention.

The features, structures, or characteristics of the invention described throughout this specification can be combined in any suitable manner in one or more embodiments. For example, the usage of the phrases “example embodiments,” “some embodiments,” or other similar language, throughout this specification refers to the fact that a particular feature, structure, or characteristic described in connection with the embodiment can be included in at least one embodiment of the present invention. Thus, appearances of the phrases “example embodiments,” “in some embodiments,” “in other embodiments,” or other similar language, throughout this specification do not necessarily all refer to the same group of embodiments, and the described features, structures, or characteristics can be combined in any suitable manner in one or more embodiments.

In addition, while the term “message” has been used in the description of embodiments of the present invention, the invention can be applied to many types of network data, such as packet, frame, datagram, etc. For purposes of this invention, therefore, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

In the present discussion of the disclosed embodiments, the following abbreviations can be used.

3GPP 3rd Generation Partnership Project

ANDSF Access Network Discovery and Selection Function

DM Device Management

GPRS General Packet Radio System

GSM Global System for Mobile Communications

HPLMN Home Public Land Mobile Network

HLR Home Location Register

HSPA High Speed Packet Data

IEEE 802.21 IEEE standard of seamless handover between networks

IMSI International Mobile Subscriber Identity

MSC Mobile Switching Center

MSISDN Mobile Station International ISDN Number

NWDS Network Discovery and Selection

OMA Open Mobile Alliance

SGSN Serving GPRS Support Node

SMS Short Message Service

SSID Service Set Identifier

WiMAX Worldwide Interoperability for Microwave Access

WLAN Wireless Local Area Network

VLR Visitor Location Register

VPLMN Visited Public Land Mobile Network

WCDMA Wideband Code Division Multiple Access

Device management (DM) is used in cellular networks to provide connectivity and service settings to subscriber devices. DM relates to provisioning the configuration of the device, including first time use, enabling and disabling features, etc., to allow changes to the settings and parameters of the device. These changes can include, for example, software upgrades to provide for new software and/or bug fixes to be loaded on the device, including applications and system software, and, can also include fault management procedures to report errors from the device and queries about the status of device.

To perform a DM operation, a user and an associated device must be known by a DM server, and typically the user and device profiles are stored in DM registers. In operation, the device connects to the specific DM server defined in a device bootstrapping phase in which initial DM session settings are sent to the device by a DM server.

Roaming users are also a substantial part of the user traffic when network traffic volumes are increasing, especially for business users. Optimization of communications and the provisioning of certain desired features, such as data downloads, messaging, etc., typically cannot be accomplished without configuring a device to operate on the visited network. DM based network discovery and selection can also be applied to roaming users. However, if a device is connected to a visited network (i.e., the device is roaming), the device does know the address of the visited network's DM system and server, and the DM system of the visited network does not have user and device profiles of the visiting user and associated device. This lack of information can prevent the usage of the DM system of the visited network by a roaming device because this type of information is typically needed to establish a DM session. Exchanging this network connectivity and service information between DM systems in visited and home networks would provide optimized access for visiting devices.

A roaming user can try to configure settings manually if she knows what to set and how to set it, but this task is often challenging and not user-friendly. Alternatively, a roaming user can contact her home public land mobile network (HPLMN) DM to obtain the required settings, but this would mean that a network operator would have to configure all details of all visited public land mobile networks (VPLMNs), which would be burdensome and unfeasible. For example, WLAN hot spots can be very dynamic, and can require the HPLMN DM to regularly update device settings associated with a large number of rapidly changing WLANs. Consequently, only a local visited public land mobile network (VPLMN) has the detailed information of trusted and preferred networks of different technologies that can be used for services, e.g., WLAN service set identifiers (SSIDs). Permitting the user and her associated device to communicate with the VPLMN DM to discover and utilize these networks can provide the user with the needed information to obtain network access and/or network connectivity.

In certain embodiments of the present application, when the network observes an unknown device in the network (e.g., a roaming user and associated device), the network creates and stores a temporary DM device and user profile that includes necessary credentials to enable the network to apply the desired DM operations to the visiting device.

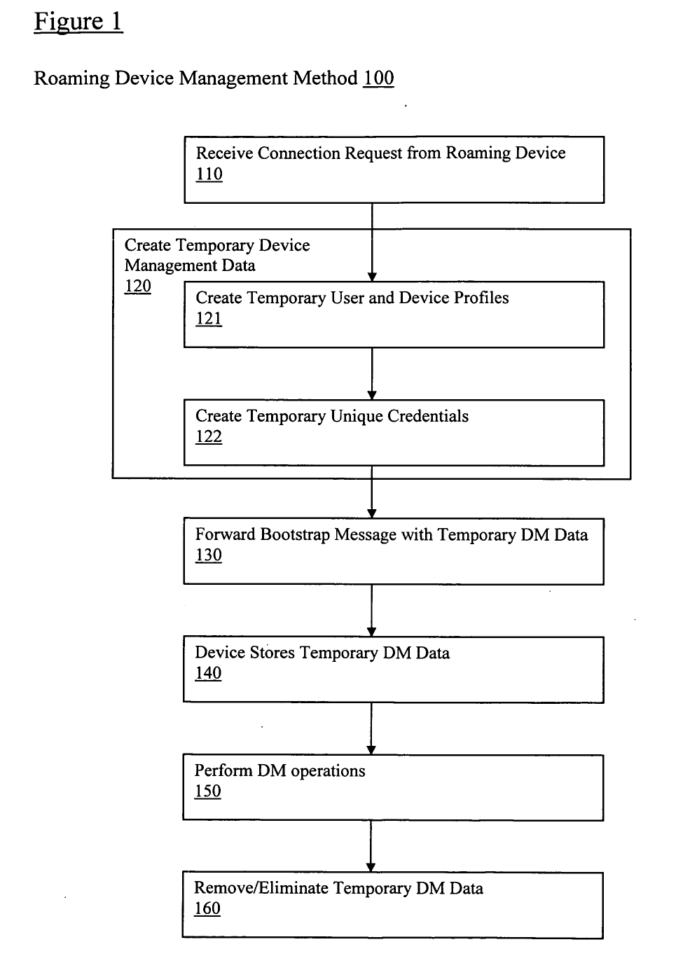

Referring to FIG. 1, a roaming DM method 100 is illustrated. The roaming DM method 100 begins when a network detects an unknown device, operation 110. For example, the roaming device can transmit a signal indicating its presence and requesting to connect to the network. A network monitoring system can detect a roaming device in the network, and the network monitoring system can obtain device specific information from network elements. For example, device management operation information, such as, a mobile station international ISDN number (MSISDN) can be transmitted with the connection request.

When the network observes an unknown device in the network (e.g. roaming user and associated device), the network can use data from the connection request in operation 110, or, from other sources to create artificial DM data in operation 120. In order to perform DM operations, both DM user and its associated device profiles are typically needed. Therefore, when a new device is observed, the DM system in a network creates temporary user and associated device DM profile entries for visiting user and associated devices in operation 121. In one implementation, a DM server can have a predefined user profile for certain visitor users, and when one of these new users needs to be registered, the DM server can create an entry for the user by combining a predefined user profile with unique authentication information. In this example, there can be no predefined association with the user and device, and, as a result, the user can be treated as a visiting user, and temporary visiting user and associated device profiles can be created in operation 121. The visiting user and device profiles created in operation 121 can be linked together by device identity information stored in DM registers of a DM registry.

Credentials are often used to perform DM operations. Thus, unique credentials, such as, username and keyword/password, used for authentication processes, can be additionally generated and added to the profiles in operation 122.

Referring to FIG. 1, in operation 130, a bootstrap message that includes initial DM settings, including authentication credentials and server information, can be sent to the device using an existing messaging mechanism, as described in greater detail below. For example, a short messaging service (SMS) can be used to send the bootstrap message. If the user accepts the initial DM session settings request, the settings will be stored in the user's memory, operation 140.

By accepting and storing the bootstrap message, the user is providing permission to the network to perform DM operations in operation 150 using conventional standard DM techniques. For example, the network can start DM operations by sending an alert request to the device (not shown). Alternatively, the roaming device can also initiate the DM process. If the device responds to the alert by connecting to the DM server, and, if the authentication procedure requested by the DM server or client succeeds, then actual DM operations can be executed (e.g., provisioning of connectivity settings). In such a case, the created DM data allows the visited network to apply DM operations to visiting devices that do not have preconfigured static DM profiles. This will enable DM operations to be offered and executed in a visited network.

The temporary DM data can be erased in operation 160. Since the roaming user is a visitor in the visited network and DM profile entries are temporary, the settings and profiles can be later removed from the device and the DM server registers. This removal of the temporary DM data can be triggered by a network monitoring system, or, by specified network elements. The DM data removal can be performed when the user and associated device are no longer in the network. In such a configuration, as long as visited network DM profiles exist, a visited network DM can begin a DM operation.

In operation 160, the roaming device can also trigger the DM data removal process when the device moves to another network, such as, back to a home network or into another visited network. In this example, a device can keep track of network identities and when the network identities change, the removing process can be initiated. Alternatively, the user can also manually cause the device to remove the DM data, but this action can require the network to create new temporary DM user and device profiles for future DM operations.

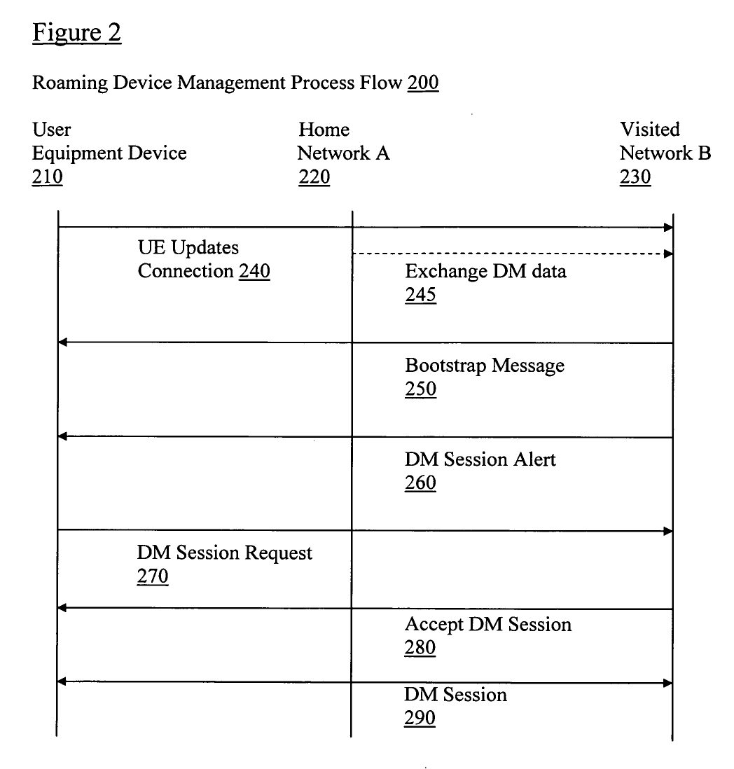

Referring now to FIG. 2, an embodiment of the present invention is illustrated using a roaming device management process flow diagram 200. In process flow diagram 200, user equipment device 210 is associated with a subscriber of a first network or home network A 220. As known from conventional DM techniques, the device 210 has connectivity settings for a home network 220. When the user travels into another visited network B 230, the device 210 can attach to this visited network 230 as a visitor. Thus, as described above, the default connectivity settings that were valid in the home network 220 are no longer usable by the device 210 in the visited network 230.

When device 210 performs location and/or routing area updates to the visited network 230 in message 240, the visited network 230 can detect whether this subscriber device 210 is roaming, by determining whether the international mobile subscriber identity (IMSI) of the device 210 is new in the network 230. When the visited network 230 determines that the device 210 is a roaming device, the visited network 230 can use the IMSI and/or other data in the message 240 to set up a visitor DM profile. As described below, the trigger to a DM system in the network 230 can be made by a visitor location register (VLR), mobile switching center (MSC), serving GPRS support node (SGSN), and/or a network element managing mobility, etc.

The visited network 230 can acquire a MSISDN number from a home location register (HLR) as a result of a location update procedure. The MSISDN can be used by the visited network 230 to create and send a bootstrap message 250 to the device 210 that contains initial settings. As described above, since the observed device 210 is new in the visited network 230, the DM system in the visited network 230 can create user and device profile entries with unique credentials and a MSISDN for the device 210 and an associated user. For example, both DM session identifiers (Session ID) and user credentials can be used to link the user and device profiles together. The actual device identity, such as, an IMSI, can remain unknown to the network 230 in this phase. However, the network 230 can learn the device identity during the establishment of a DM session. The visited network 230 can then use client provisioning to send initial DM settings in the bootstrap message 250 to the device 210. The device 210 receives the initial settings 250 and stores them in the memory.

If the DM system in the visited network 230 has settings to provision to the device 230, the visited network 230 can send a DM session alert 260 to the device 210 to trigger a DM session. The device 210 can then forward a DM session request 270 to the network 230 to start the DM operation by establishing a connection to the DM system. The DM session request 270 includes necessary information for the DM sessions, such as, a Session ID from the alert request 270. The initial session settings in the DM session request 270 can also further include credentials for authentication and server information. Thus, when the device 210 connects to the DM server of the visited network 230 as a result of the session request 270, a necessary authentication procedure can be executed, if requested, and the DM server can accept the request, message 280.

To establish the DM session 290, the device 210 can send credentials to the DM server of the visited network 230 that can check these credentials against a previously created visitor profile that was created for the visitor device 210 using the connection updates 240. The DM server in the visited network can then send its credentials to the device 210, which can then check these credentials against settings it received in the initial settings of the bootstrap message 250. Such credentials can be part of any of the various messages illustrated in FIG. 2 or can be its own separate message sent to the device 210.

After successful authentication, a DM session 290 is established to execute a DM operation. For example, the DM server in the visited network 230 can provision network specific connectivity settings and send those settings to the device 210. Then, the device 210 can use those updated DM settings based on its policies, for example, to access and use certain services, such as, to connect to the Internet.

As an alternative, or, in addition to the updating message 240 from the device 210, the DM system in visited network 230 can receive information (e.g., full/subset of a user/device profile) from a DM system in the home network 220 during a network registration procedure, via a DM data exchange message 245. For example, a HLR in the home network 220 can trigger a DM system in the home network 220 to provide required information to the DM system of the visited network 230. The DM data message 245 can be sent either directly or via other mobility management messaging, such as an HLR update location message.

As described above, when the user takes the roaming device 210 away from the visited network 230, the roaming device 210 can store the current connectivity settings and tag them with an appropriate network identifier. That way, if the user returns back to this visited network 230 at a later time, the roaming device 210 can use the existing connectivity settings to re-connect to the same visited network 230. This communication can be re-established between the roaming device 210 and the visited network 230 when the roaming device 210 re-enters the communication range of the visited network.

The device 210 can also request for further updates for the connectivity settings in the connection update message 230. Alternatively, the temporary DM settings can be removed from the device 210 and from profile entries from the DM registers in the visited network 230. For example, removal of the temporary DM settings can be triggered when a HLR location cancel message is sent to the HLR location registry.

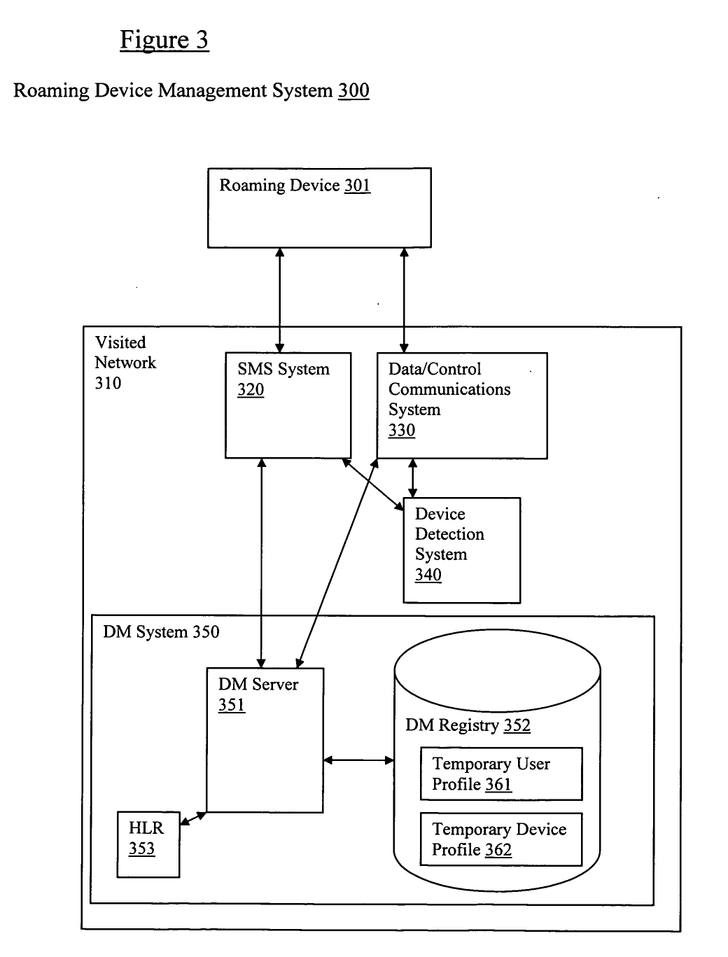

Referring now to FIG. 3, a roaming device management system 300 can be configured to implement roaming operations. The roaming DM network 300 specifically depicts a roaming device 301 receiving DM services from a visited network 310. As illustrated in FIG. 3, the roaming device 301 can communicate with the visited network 310 via a SMS system 320. For example, as described above, the mobile device 301 can interact with the VLR, the MSC, or the SGSN of the visited network (not shown) by using the SMS system 320. Alternatively, the roaming device 301 can communicate with the visited network 310 through other conventional data control communications systems 330.

As described above, the visited network 310 receives information, such as the IMSI of the device 301, and uses this information and device detection system 340 to determine whether the device 310 is new in the visited network 310.

When the visited network 310 determines that the device 301 is roaming, a DM system 350 can use the IMSI and/or other data to set up a visiting DM profile. For example, the DM system 350 can acquire a MSISDN number from a home location register (HLR) 353 as a result of location update procedure. The MSISDN can be used by a DM server 351 to form and send a bootstrap message that contains initial settings to the device 301.

As described above, since the device 301 is new in the network 310, the DM server 351 can create a temporary user profile 361 and a temporary device profile 362, which can be provided as entries in a DM register 352. The user profile 361 and device profile 362 typically include unique credentials and a MSISDN for the device 301 and an associated user. For example, both DM session identifier (Session ID) and used credentials can be used to link the two profiles 361 and 362 together. The DM server 351 can then use a client provision service to send initial DM settings in a bootstrap message to the device 301 that receives and stores the initial settings.

For example, the DM system 350 can implement open mobile alliance (OMA) DM. The OMA DM specification is designed for management of small mobile devices such as mobile phones, PDAs and palm top computers. Typically, OMA DM uses extended meta language XML for data exchange. The device management takes place by communication between the DM server 351 and the client (e.g., the device 301 being managed). A DM system 350 using OMA DM can support and utilize a number of data transports, such as GSM, CDMA, infrared data association (IrDA) or Bluetooth or transport layers implemented over any of wireless session protocol (WSP)/wireless application protocol (WAP), hypertext transfer protocol (HTTP), object exchange (OBEX), or, similar transport system protocols.

As described above in FIG. 2, the communication protocol in DM, such as OMA DM, is a request-response protocol in which authentication and challenge of authentication are built-in to ensure the server and client are communicating only after proper validation. The server 351 and client device 301 are both subject to authentication such that a specific sequence of messages are to be exchanged only after authentication is completed prior to performing any task.

As discussed above, various embodiments of the invention can be configured in numerous physical elements, or can be configured at a single network element or configured in a number of elements having various disclosed functions distributed throughout. The control of the DM or other monitoring configurations and other functions can be performed at various network components, such as, at a user equipment (UE), at various components of the base station (BS), or at another network component associated with the wireless network.

Accordingly, it can be seen that certain embodiments of the present application relate to a method in which a network receives connection information of a roaming device. The network uses this connection information to form temporary user and device profiles. These temporary profiles are used to form a bootstrap message. This bootstrap message is forwarded to the device to initiate a DM session. Optionally, the network is further configured to receive a request from the device to initiate the DM session. The network can also be optionally configured to receive DM data from a home network associated with the device.

In certain other embodiments, a computer program embodied on a computer-readable medium is configured to control a processor to receive connection information of a roaming device. The processor uses this connection information to form temporary user and device profiles. These temporary profiles are used to form a bootstrap message. This bootstrap message is forwarded to the device to initiate a DM session. Optionally, the processor is further configured to receive a request from the device to initiate the DM session. The processor can also be optionally configured to receive DM data from a home network associated with the device. The operations of a method or algorithm described in connection with the embodiments disclosed herein can be embodied directly in hardware, in a computer program executed by a processor, or in a combination of the two.

A computer program can be embodied on a computer readable medium, such as a storage medium. For example, a computer program can reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art. A storage medium can be coupled to the processor such that the processor can read information from, and write information to, the storage medium. In the alternative, the storage medium can be integral to the processor. The processor and the storage medium can reside in an application specific integrated circuit (“ASIC”). In the alternative, the processor and the storage medium can reside as discrete components.

In certain other embodiments, an apparatus receives connection information of a roaming device. The apparatus uses this connection information to form temporary user and device profiles. These temporary profiles are used by the apparatus to form a bootstrap message. The apparatus then sends this bootstrap message to the device to initiate a DM session. Optionally, the apparatus is further configured to receive a request from the device to initiate the DM session. The apparatus can also be optionally configured to receive DM data from a second home network associated with the device.

A person of ordinary skill in the art would understand that the above-discussed embodiments of the invention are for illustrative purposes only, and that the invention can be embodied in numerous configurations as discussed above. Additionally, the invention can be implemented as a computer program on a computer readable medium, where the computer program controls a computer or a processor to perform the various functions which are discussed as method operations and also discussed as hardware or hardware/software elements.

What is claimed is:

1. A method, comprising:
receiving, at a network device, connection information of a roaming device;
creating at least one of a user profile and a corresponding roaming device profile in response to receiving the connection information; and
initiating a device management session.

2. The method of claim 1, wherein initiating the device management session comprises
creating a bootstrap message based on at least one of the user profile and the corresponding roaming device profile; and
forwarding the bootstrap message to initiate a device management session.

3. The method of claim 1, further comprising:
requesting authentication of the roaming device prior to initiating said device management session.

4. The method of claim 1, further comprising:
receiving a request from the roaming device to initiate the device management (DM) session.

5. The method of claim 1, further comprising:
receiving device management data from a home network associated with the roaming device.

6. The method of claim 2, wherein creating a bootstrap message based on at least one of the user profile and the corresponding roaming device profile comprises creating at least one of a temporary user profile and a corresponding temporary roaming device profile.

7. The method of claim 6, further comprising:
storing at least one of the temporary user profile and the corresponding temporary roaming device profile in a device management registry of the network device.

8. The method of claim 1, wherein the network device configured to receive connection information of a roaming device comprises a device management server.

9. The method of claim 1, further comprising:
receiving a request to create the session at the network device from the roaming device.

10. The method of claim 1, further comprising:
transmitting a location cancel message in response to the roaming device leaving the visited network; and
removing at least one of the temporary user profile and the corresponding temporary roaming device profile.

11. The method of claim 1, wherein connection information received at the network device includes an international mobile subscriber identity.

12. The method of claim 1, further comprising:
linking at least one of the temporary user profile and the corresponding temporary roaming device profile together by associating a device manager session identifier and user credentials, which includes at least one of a username and password.

13. An apparatus, comprising:
a receiver configured to receive connection information of a roaming device;
a processor configured to create at least one of a user profile and a corresponding roaming device profile in response to receiving the connection information, and to initiate a device management session.

14. The apparatus of claim 13, wherein said processor is further configured to create a bootstrap message based on at least one of the user profile and the corresponding roaming device profile.

15. The apparatus of claim 13, further comprising:
a transmitter configured to transmit a bootstrap message to initiate a device management session.

16. The apparatus of claim 13, wherein the receiver is further configured to receive a request from the roaming device to initiate the device management session.

17. The apparatus of claim 13, wherein the receiver is further configured to receive device management data from a home network associated with the roaming device.

18. The apparatus of claim 13, wherein the processor that is configured to create at least one of the user profile and the corresponding roaming device profile, is further configured to create at least one of a temporary user profile and a corresponding temporary roaming device profile.

19. The apparatus of claim 18, further comprising:
a memory registry configured to store at least one of the temporary user profile and the corresponding temporary roaming device profile in a device management registry.

20. The apparatus of claim 13, wherein the apparatus comprises a device management server.

21. The apparatus of claim 13, wherein the receiver is further configured to receive a request from the roaming device to create the device management session.

22. The apparatus of claim 18, further comprising
a transmitter configured to transmit a location cancel message in response to the roaming device leaving the visited network;
and wherein said processor is further configured to remove at least one of the temporary user profile and the temporary corresponding roaming device profile.

23. The apparatus of claim 13, wherein the receiver is configured to receive connection information that comprises an international mobile subscriber identity.

24. The apparatus of claim 18, wherein the processor is further configured to link at least one of the temporary user profile and the corresponding temporary roaming device profile together by associating a device manager session identifier and user credentials, which includes at least one of a username and password.

25. A method, comprising:
transmitting, via a user equipment, connection information of a roaming user equipment to a network device; and
in response to transmitting the connection information, initiating a device management session between the user equipment and the network device.

26. The method of claim 25, wherein initiating a device management session further comprises:
receiving a request for authentication;
performing an authentication procedure; and
initiating a device management session with the network device in response to the authentication procedure being successful.

27. The method of claim 25, wherein initiating a device management session further comprises:
receiving an alert message from the network device; and
sending, based on the alert, a request to said network device to initiate the device management session.

28. The method of claim 27, further comprising:
receiving from the network device a bootstrap message comprising at least one of a user profile and a corresponding roaming device profile in response to sending said request to said network device.

29. The method of claim 25, wherein initiating a device management session further comprises:
receiving a bootstrap message configured to initiate a device management session, said bootstrap message comprising at least one of a user profile and a corresponding roaming device profile.

30. An apparatus, comprising:
a transmitter configured to transmit connection information of a roaming user equipment to a network device; and
a processor configured to initiate a device management session between the user equipment and the network device in response to transmitting the connection information.

31. The apparatus of claim 30, further comprising:
a receiver configured to receive a bootstrap message that comprises device management initiation information of the device management session, in response to said transmitted connection information, said bootstrap message comprising at least one of a user profile and a corresponding roaming device profile.

32. A computer readable medium configured to store computer software code that when executed causes a processor to perform:
receiving, at a network device, connection information of a roaming device;
creating at least one of a user profile and a corresponding roaming device profile in response to receiving the connection information; and
initiating a device management session.

33. The computer readable medium of claim 32, wherein the processor is further configured to perform:
creating a bootstrap message based on at least one of the user profile and the corresponding roaming device profile; and
forwarding the bootstrap message to initiate a device management session.

34. A computer readable medium configured to store computer software code that when executed causes a processor to perform:
transmitting, via a user equipment, connection information of a roaming user equipment to a network device; and
in response to transmitting the connection information, initiating a device management session between the user equipment and the network device.

35. The computer readable medium of claim 34, wherein the processor is further configured to perform:
receiving a bootstrap message configured to initiate the device management session, said bootstrap message comprising at least one of a user profile and a corresponding roaming device profile.

36. An apparatus, comprising:
receiving means for receiving connection information of a roaming device; and
processing means for creating at least one of a user profile and a corresponding roaming device profile in response to receiving the connection information.

37. The apparatus of claim 36, further comprising:
bootstrap processing means for creating a bootstrap message based on at least one of the user profile and the corresponding roaming device profile; and
transmitting means for transmitting the bootstrap message to initiate a device management session.

38. An apparatus, comprising:
transmitting means for transmitting connection information of a roaming user equipment to a network device; and
initiating means for initiating a device management session between the user equipment and the network device in response to transmitting the connection information.

39. The apparatus of claim 38, further comprising:
receiving means for receiving a bootstrap message configured to initiate a device management session, in response to said transmitted connection information, said bootstrap message comprising at least one of a user profile and a corresponding roaming device profile.

40. A method, comprising:
ending a session between a roaming device and a visited network;
storing and tagging connectivity settings of the ended session with the visited network in response to the roaming device moving out of the visited network; and
re-connecting a connection between the roaming device and the visited network in response to the roaming device re-entering the communication range of the visited network by using the connectivity settings of the ended session used prior to re-connecting the connection.

41. The method of claim 40, further comprising:
requesting an update for current connectivity settings during the re-connection procedure.

42. A computer readable medium configured to store computer software code that when executed causes a processor to perform:
ending a session between a roaming device and a visited network;
storing and tagging connectivity settings of the ended session with the visited network in response to the roaming device moving out of the visited network; and
re-connecting a connection between the roaming device and the visited network in response to the roaming device re-entering the communication range of the visited network by using the connectivity settings of the ended session used prior to re-connecting the connection.

43. An apparatus, comprising:
a memory configured to store and tag connectivity settings of an ended session between the apparatus and a visited network in response to the apparatus moving out of the visited network; and
a transmitter configured to re-connect a connection between the apparatus and the visited network in response to the apparatus re-entering the communication range of the visited network by using the connectivity settings of the ended session used prior to re-connection of the connection.

44. The apparatus of claim 43, wherein the transmitter is further configured to send an update request to receive current connectivity settings during the re-connection of the connection.

45. An apparatus, comprising:
storing means for storing and tagging connectivity settings of an ended session between the apparatus and a visited network in response to the apparatus moving out of the visited network; and
transmitting means for transmitting a message for re-connecting a connection between the apparatus and the visited network in response to the apparatus re-entering the communication range of the visited network by using the connectivity settings of the ended session used prior to re-connection of the connection.

46. A method, comprising:
observing a roaming device in a network;
exchanging network connectivity and service information between said network and a home network of said roaming device;
creating at least one of a temporary device profile and a temporary user profile, said at least one profile comprising credentials to enable said network to apply device management operations to said roaming device;
generating authentication credentials for said at least one profile;
adding said credentials to said at least one profile; and
initiating a device management session.

47. An apparatus, comprising:
a receiver configured to receive a signal confirming that a roaming device is operating in a network;
a transmitter configured to exchange network connectivity and service information between said network and a home network of said roaming device; and
a processor configured to
create at least one of a temporary device profile and a temporary user profile, said at least one profile comprising credentials to enable said network to apply device management operations to said roaming device,
generate authentication credentials for said at least one profile,
add said credentials to said at least one profile, and
initiate a device management session.

48. An apparatus, comprising:
receiving means for receiving a signal confirming that a roaming device is operating in a network;
transmitting means for exchanging network connectivity and service information between said network and a home network of said roaming device;
creating means for creating at least one of a temporary device profile and a temporary user profile, said at least one profile comprising credentials to enable said network to apply device management operations to said roaming device;
generating means for generating authentication credentials for said at least one profile;
adding means for adding said credentials to said at least one profile; and
initiating means for initiating a device management session.
